(19) United States
(12) Patent Application Publication
(10) Pub. No.: US 2019/0089177 A1
(43) Pub. Date: Mar. 21, 2019

(54) POWER RECEPTION DEVICE AND CHARGING CONTROL PROGRAM

(71) Applicant: TOSHIBA TEC KABUSHIKI KAISHA, Tokyo (JP)

(72) Inventor: Masakazu Kato, Numazu Shizuoka (JP)

(21) Appl. No.: 16/195,919

(22) Filed: Nov. 20, 2018

Related U.S. Application Data
(63) Continuation of application No. 15/725,464, filed on Oct. 5, 2017.

(30) Foreign Application Priority Data
Oct. 5, 2016 (JP) 2016-196991

(51) Int. Cl. H02J 7/00; B41J 29/13; B41J 29/393; H02J 50/10; H02J 7/02; H02J 50/80; B41J 2/35; H02J 7/04; H02J 50/90

(52) U.S. Cl. CPC H02J 7/0047; B41J 29/13; B41J 29/393; H02J 50/10; H02J 50/90; H02J 50/80; B41J 2/35; H02J 7/04; H02J 7/025

(57) ABSTRACT

According to one embodiment, there is provided a power reception device including: a power reception coil, a power reception unit, a notification unit, and a control unit. The power reception coil receives power from a power supply device in a non-contact manner. The power reception unit causes the received power as a charging current to flow to a load. The notification unit notifies that a relative position of the power reception device to the power supply device is inappropriate. The control unit starts charging by the charging current which is set to a first current value and controls the charging current so as to gradually increase the charging current. If the charging is stopped before the charging current reaches a second current value larger than the first current value, notification is performed that the relative position of the power reception device to the power supply device is inappropriate.

### CROSS-REFERENCE TO RELATED APPLICATIONS

This application is a Continuation of application Ser. No. 15/725,464 filed on Oct. 5, 2017, the entire contents of which are incorporated herein by reference.

This application is based upon and claims the benefit of priority from Japanese Patent Application No. P2016-196991, filed Oct. 5, 2016, the entire contents of which are incorporated herein by reference.

### FIELD

Embodiments described herein relate generally to a power reception device having a contactless charging function and a charging control program of such a power reception device.

### BACKGROUND

Recently, there is a technology to charge a power reception device such as a smart phone or a portable printer in a non-contact manner without connecting the power reception device with a power supply device through a cable. In other words, a user can charge the power reception device only by placing the power reception device on the power supply device. On the other hand, in order to efficiently perform non-contact charging, the user needs to place a power transmission coil in the power supply device and a power reception coil in the power reception device so that positions thereof match each other. Therefore, preferably, the user can determine whether or not the power reception device is placed at a correct position on the power supply device.

### DESCRIPTION OF THE DRAWINGS

FIG. 1 is an external appearance view illustrating an example of a power supply device and a power reception device according to a first embodiment.

FIG. 2 is a block diagram illustrating configurations of the power supply device and the power reception device.

FIG. 3 is a plan view of the power supply device.

FIG. 4 is a table illustrating a relationship between a region where the power reception device is placed and charging efficiency.

FIG. 5 is a diagram illustrating control by a control unit of the power reception device.

FIG. 6 is a table illustrating the charging efficiency and the region at each charging current.

FIGS. 7A to 7C are diagrams illustrating an example of display on a display unit.

FIG. 8 is a flowchart illustrating the control of the control unit.

FIG. 9 is a diagram illustrating control by a control unit of a power reception device according to a second embodiment.

FIG. 10 is a diagram illustrating another example of the control by the control unit of the power reception device.

### DETAILED DESCRIPTION

An object of an exemplary embodiment is to provide a power reception device which can notify a user that the power reception device is not placed at a correct position on a power supply device.

In general, according to one embodiment, there is provided a power reception device including a power reception coil, a power reception unit, a notification unit, and a control unit.

The power reception coil receives power from the power supply device in a non-contact manner. The power reception unit causes the received power as a charging current to flow to a load. The notification unit notifies that a relative position of the power reception device to the power supply device is inappropriate. The control unit starts charging by a charging current which is set to a first current value and controls the charging current so as to gradually increase the charging current. When the charging is stopped before the charging current reaches a second current value larger than the first current value, notification is performed that the relative position of the power reception device to the power supply device is inappropriate based on the current value of the charging current when the charging is stopped.

Hereinafter, embodiments will be described with reference to the drawings.

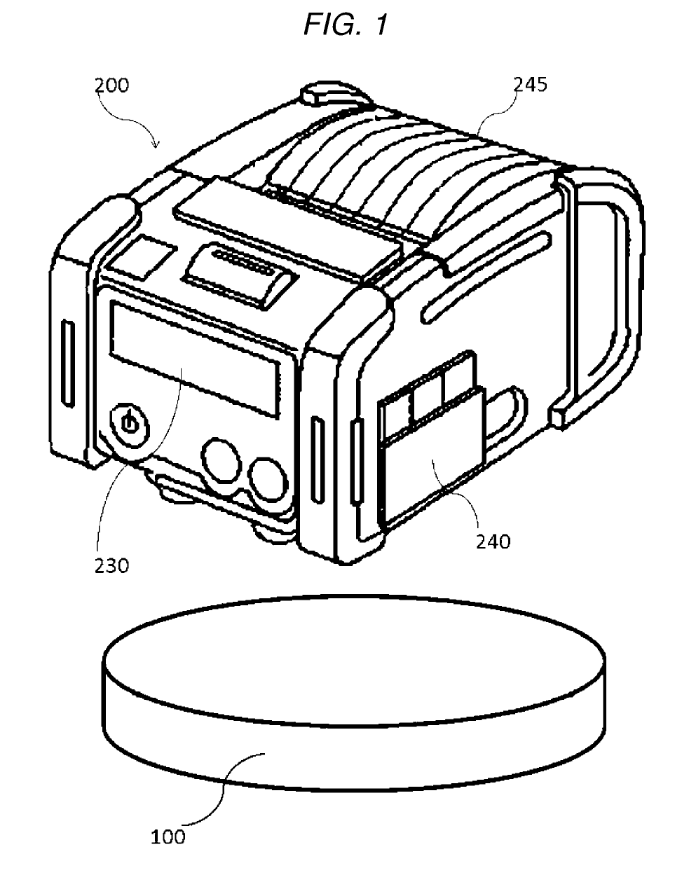

FIG. 1 is an external appearance view illustrating a power supply device 100 and a power reception device that is charged by the power supply device 100. In the embodiment, a portable printer 200 (hereinafter, simply referred to as printer 200) will be described as an example of the power reception device.

The power supply device 100 is configured of a flat plate-shaped casing on which the printer 200 is placed, and includes a power transmission coil 105 above an inside portion of the casing (on side close to printer 200). The power supply device 100 includes an LED or the like which displays a power transmission state. In addition, the power supply device 100 includes a configuration that includes a power transmission coil 105 and transmits power in a non-contact manner.

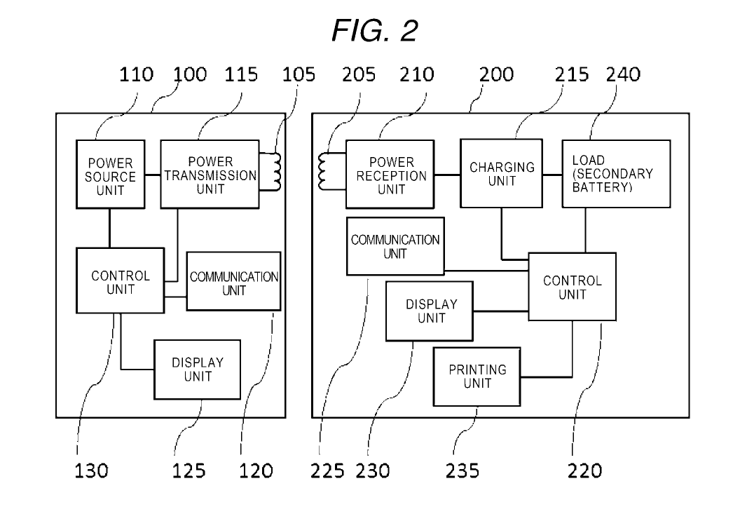

The printer 200 can be charged in a non-contact manner by being placed on the power supply device 100. In the printer 200, the power reception coil 205 is placed below the inside portion of the casing (on side close to power supply device 100) so as to face the power transmission coil 105. The printer 200 includes an openable and closable cover 245 that loads and unloads other printing paper, a display unit 230, a secondary battery 240 as a load, and the power reception coil 205, and has a configuration that receives power in a non-contact manner, and the like. A configuration relating to power transmission and charging in a non-contact manner will be described in detail with reference to FIG. 2.

As illustrated in FIG. 1, if the printer 200 is placed on the power supply device 100, the secondary battery 240 in the printer 200 is charged. Specifically, in a state where the power transmission coil 105 of the power supply device 100 and the power reception coil 205 of the printer 200 are within a predetermined distance, the printer 200 receives power supply from the power supply device 100. Although the power supply device 100 transmits power by a magnetic field coupling manner such as electromagnetic induction manner, for example, the manner is not limited thereto. Hereinafter, a case where power is transmitted by the electromagnetic induction manner will be described as an example.

FIG. 2 is a block diagram of the power supply device 100 and the printer 200 according to the embodiment.

The power supply device 100 includes a power source unit 110, a power transmission unit 115, a communication unit 120, a display unit 125, and a control unit 130.

The power source unit 110 is supplied with power from an AC adaptor or the like provided outside or inside the power supply device 100 and supplies power appropriate for each unit in the power supply device 100.

The power transmission unit 115 includes an oscillation unit that generates a high-frequency signal and a power amplification unit that amplifies the generated high-frequency signal. A DC voltage supplied from the power source unit 110 is converted into an AC voltage, generates high-frequency power, and transmits power from the power transmission coil 105.

The communication unit 120 includes an interface that performs a communication with a communication unit 225 (to be described below) of the printer 200 by a wireless communication unit by electric waves or infrared rays or the like, or a communication unit that performs load modulation of a carrier wave used for power transmission, or the like. By communicating with the communication unit 225, the communication unit 120 receives information of a power value received by the printer 200 and transmits the information to the control unit 130 to be described below.

In addition to a liquid crystal display device, the display unit 125 may be an input and output device such as a touch panel.

The control unit 130 includes a CPU as a computation device and a memory as a storage device. The control unit 130 controls power to be transmitted from the power transmission unit 115 based on a request sent from the printer 200 via the communication unit 120. A threshold value Th for limiting the current flowing from the power transmission unit 115 to the power transmission coil 105 is stored in the memory and if the current value exceeds the threshold value Th, the control unit 130 controls the power transmission so as to stop the power transmission by the power transmission unit 115. The threshold value Th is set based on the maximum value of the power that can be transmitted by the power supply device 100.

The printer 200 includes a power reception coil 205, a power reception unit 210, a charging unit 215, a control unit 220, a communication unit 225, a display unit 230, a printing unit 235, and a secondary battery 240 as a load.

The power reception coil 205 receives power by a magnetic field coupling such as electromagnetic induction with the power transmission coil 105.

The power reception unit 210 includes a rectifying unit that rectifies AC power received by the power reception coil 205 into DC power and a DC/DC unit that converts a voltage. The power reception unit 210 converts the DC voltage generated by the rectifying unit into a DC voltage appropriate for an operation of the charging unit 215 to be described below and supplies the DC voltage to the charging unit 215.

The charging unit 215 generates a voltage and a current appropriate for charging the load (secondary battery) 240 and charges the secondary battery 240. Hereinafter, the current supplied from the charging unit 215 to the secondary battery 240 is set as a charging current.

The control unit 220 includes a CPU as a computation device and a memory as a storage device. In addition, the control unit 220 measures a voltage output from the power reception unit 210, and requests the power supply device 100 to adjust the transmitted power via the communication unit 225 so that a voltage value required by the charging unit 215 can be obtained. In addition, the control unit 220 sets a current value of the charging current with respect to the charging unit 215 so that an actual current value of the received current can be detected. Therefore, if there is a difference between the set current value of the charging current and the actual current value of the charging current, adjustment of the transmitted power can be requested to the power supply device 100 via the communication unit 225. In addition, when the control unit 220 detects that the charging current is zero despite of setting the charging current so as to charge the secondary battery 240 with a predetermined current value, the control unit determines that power transmission is stopped by the power supply device 100.

The communication unit 225 includes an interface that performs a communication with the communication unit 120 of the power supply device 100 by a wireless communication unit by electric waves or infrared rays, or a communication unit that performs load modulation of a carrier wave used for power transmission, or the like.

The display unit 230 displays a state of a position of the power reception device or the like. In addition to a liquid crystal display device, the display unit 230 may be an input and output device such as a touch panel. In the embodiment, the display unit 230 corresponds to the notification unit.

The printing unit 235 includes a thermal head and a platen roller. For example, the thermal head performs printing by heating a heat sensitive type sheet based on a print command from a host computer. The platen roller is rotationally driven by the control unit 220 in synchronization with a printing operation.

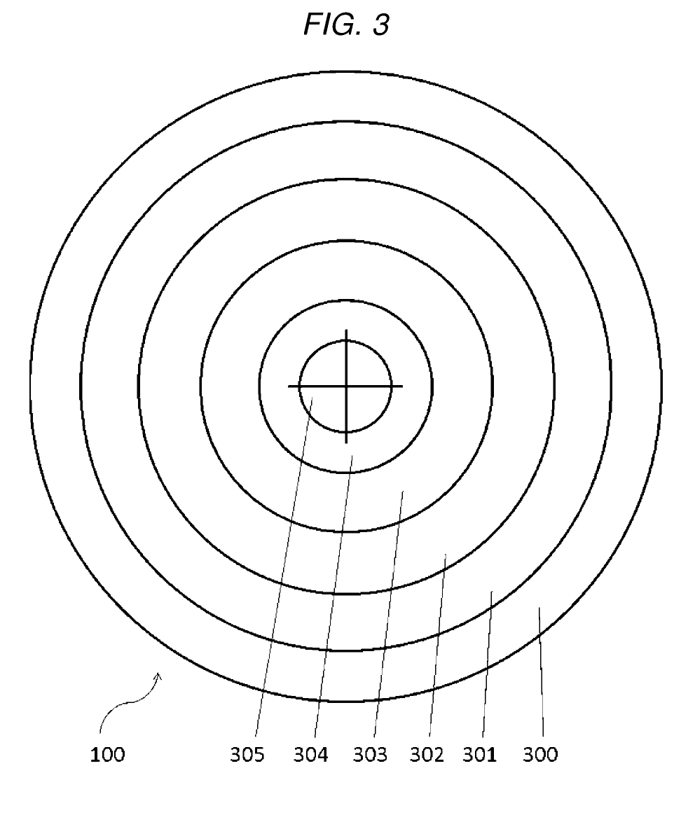

FIG. 3 is a plan view of the power supply device 100. Charging efficiency varies depending on where the printer 200 is placed on the power supply device 100. Specifically, if the power transmission coil 105 of the power supply device 100 is provided at the center of the power supply device 100, the charging efficiency becomes gradually higher as the position where the power reception coil 205 which is provided in the printer 200 is placed is close to the center of the power supply device 100.

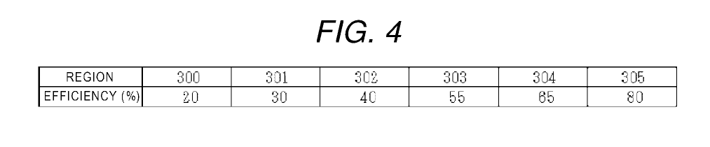

FIG. 4 is a table illustrating an example of a relationship between a region where the printer 200 is placed and the charging efficiency, based on the properties described above.

Here, if the charging continues in a state where the charging efficiency is low, since the power loss increases, not only the heat generation of the power supply device 100 increases but also the power supply device 100 may stop power transmission. Specifically, since the position of the printer 200 is poor and the charging efficiency decreases, there is a case where the printer 200 cannot receive the minimum power necessary for charging. At this time, although the printer 200 repeatedly requests the power supply device 100 to increase the power transmission amount, as a result, if the power transmission amount exceeds the maximum power that can be transmitted by the power supply device 100, the power supply device 100 stops power transmission. Specifically, if the current value of the current flowing from the power transmission unit 115 to the power transmission coil 105 exceeds the threshold value Th, the power supply device 100 controls the power transmission so as to stop power transmission by the power transmission unit 115.

Once the power supply device 100 stops power transmission, for example, the power supply device 100 stops transmitting power until the position of the printer 200 is changed. Therefore, in this case, the user needs to receive a notification that the printer 200 is not placed at a correct position on the power supply device 100.

With respect to such a problem, in the printer 200 of the embodiment, the control unit 220 sets a charging current to start the charging from a small current value and thereafter gradually increase the current value. Accordingly, the charging efficiency and the position where the printer 200 is placed are estimated based on the charging current which is set when power transmission from the power supply device 100 is stopped.

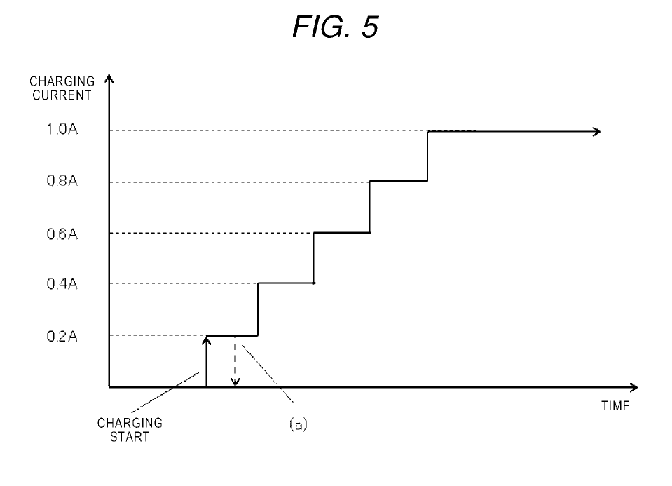

FIG. 5 is a diagram illustrating control by the control unit 220 of the printer 200 according to a first embodiment. When the printer 200 is placed on the power supply device 100, the control unit 220 sets the charging current to a small value and starts charging. Thereafter, the control unit 220 controls the charging unit 215 so as to increase the charging current at predetermined time intervals. In the example of FIG. 5, the control unit 220 starts charging at 0.2 A and increases the charging current by 0.2 A at predetermined time intervals.

Here, if the transmission power of the power supply device 100 is set to P1 and the power received by the printer 200 is set to P2, the efficiency E (%) of non-contact charging is given by the following equation.

E=(P2/P1)×100 (1)

Further, if the charging voltage of the printer 200 is V2 and the power consumed by the printer 200 such as the control unit 220 other than the power charging the secondary battery 240 is P3, the charging current I can be expressed as follows.

(P2−P3)/V2=I (2)

By equations (1) and (2),

E=((V2×I+P3)/P1)×100 (3)

Since the charging voltage V2, the power P3 other than the charging, and the transmitted power P1 are known values in advance, if the charging current I is detected when the power transmission is stopped, the control unit 220 can calculate the charging efficiency E and can estimate a position where the printer 200 is placed at the same time.

Next, control of the control unit 220 will be specifically described as an example of the following conditions.

Transmission power P1: 7 W (maximum)

Charging voltage V2: 4.2V (maximum)

Power consumption P3 of the control unit 220 or the like: 0.5 W

In the example described above, if a load is applied to the power supply device 100 such that the power transmission output exceeds 7 W, the power supply device 100 stops power transmission. In addition, the charging voltage is the maximum value if the secondary battery 240 as a load is a lithium ion battery of one cell. In addition, the power consumption P3 of the control unit 220 or the like indicates power consumed by the printer 200 such as the control unit 220 other than the power charging the secondary battery 240. In addition, the charging current value appropriate for charging is set to 1.0 A.

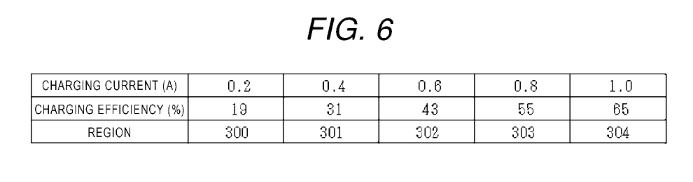

Under such a condition, the control unit 220 starts charging. If the charging is stopped when the charging current is 0.2 A (FIG. 5(a)) and if 0.2 A is used in the above equation (3), the charging efficiency E becomes E=(4.2×0.2+0.5/7)×100=19(%) and thus a fact is obtained that the charging efficiency is 19%. Therefore, from FIG. 5, the control unit 220 determines as being placed in the vicinity of the region 300. Similarly, the charging efficiency and the region where the printer 200 is placed can be determined when the power transmission of the power supply device 100 is stopped at each current value of 0.4 A, 0.6 A, 0.8 A, and 1.0 A of charging currents. FIG. 6 is a table illustrating examples of the charging efficiency and the region at each of the charging currents.

In this manner, the control unit 220 determines the region where the printer 200 is placed based on the current value of the charging current when the charging is stopped. Based on the region where the printer 200 is placed, the control unit 220 displays on the display unit 230 that the position is inappropriate and the charging cannot be performed, the printer 200 is placed at a proper position, or the like, and thus notifies the user of a position state thereof.

As an example, although the charging voltage V2 of the printer 200 is treated as 4.2V, 4.2V is a value in a state where the secondary battery 240 is close to full charge. Therefore, the charging voltage V2 may be calculated as 3.5V or 4.0V, for example, depending on the battery capacity.

In the example, although the control unit 220 calculates the charging efficiency based on the current value of the charging current when the charging is stopped, the control unit 220 may calculate the current value between the charging current values before the charging current increases or before the charging current increases and when the charging is stopped.

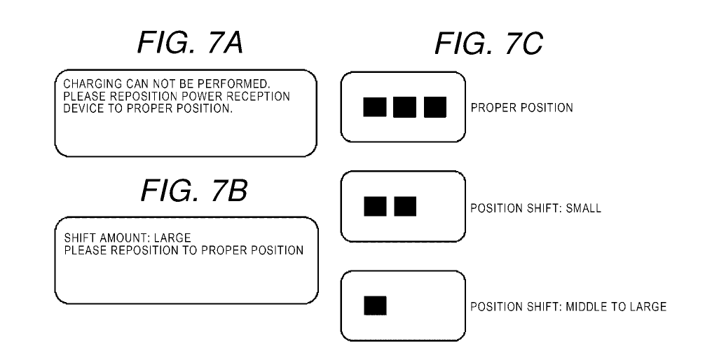

FIGS. 7A to 7C are diagrams illustrating an example of display on the display unit 230. As illustrated in FIGS. 7A and 7B, each message is displayed on the display unit 230 of the printer 200. In addition, as illustrated in FIG. 7C, the user receives a notification by a bar that changes according to whether or not the position of the printer 200 is at a proper position or how far the position is shifted being turned on a portion of the printer 200 by an LED.

Contents to be displayed are not limited to the contents described above, and for example, the charging efficiency or the estimated position may be displayed as a numerical value. In addition, in the embodiment, although the display unit of the power reception device is described as an example of the notification unit, the display unit is not limited to this. For example, the notification unit can also adopt a form that notifies whether or not the position of the printer 200 is at a proper position or how far the position is shifted by sound.

These notifications are not limited to those by the notification unit provided in the printer. For example, by communication with an external device such as a smart phone, the printer 200 may notify by the notification unit of the external device.

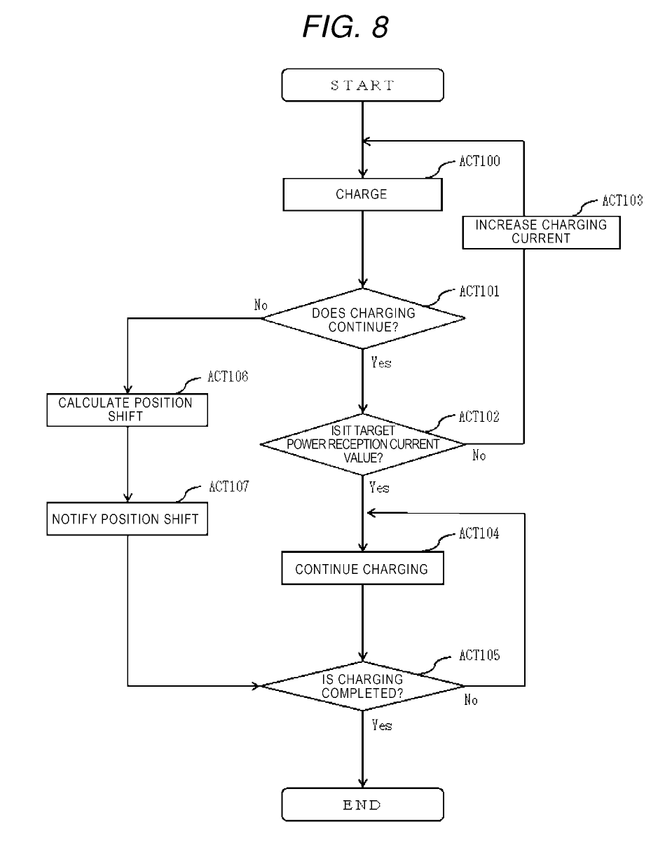

FIG. 8 is a flowchart illustrating the control of the control unit 220 according to the first embodiment.

For example, if the printer 200 is placed on the power supply device 100, the control unit 220 starts charging control by the set current value of the charging current (Act 100). The current value of the charging current when the charging is started is stored in the memory, which is 0.2 A in the example of FIG. 5. At this time, the control unit 220 controls the transmission power so as to increase the transmission power to the power supply device 100 until the charging current of the set current value is caused to flow. However, if the printer 200 is placed at an improper position, the power transmission efficiency is decreased and exceeds the maximum value of the power transmission capacity of the charging unit 215, and there is a case where the power transmission is stopped. Therefore, the control unit 220 confirms whether or not power transmission from the power supply device 100 is stopped (Act 101). If the control unit detects that the power transmission is stopped, the control unit 220 calculates how far the printer 200 is placed to be shifted based on the set current value of the charging current (Act 106).

Next, the control unit 220 displays on the display unit 230 that the position of the printer 200 is shifted from the calculated result (Act 107). At this time, the control unit 220 may change the display content according to the shift amount of the printer 200.

Thereafter, since the printer 200 cannot be charged until the printer is placed at an appropriate position by the user, the control unit 220 ends the charging (Act 105, Yes), and ends a series of control.

On the other hand, if power transmission of the power supply device 100 continues in the Act 101 (Act 101, Yes), the control unit 220 changes control according to whether or not the current value of the charging current reaches the preset target value in the control unit 220. In the example of FIG. 5, the target value of the charging current is 1.0 A.

If the current value of the charging current does not reach the target value, the control unit 220 increases the charging current by a predetermined amount (Act 103). In the example of FIG. 5, the control unit 220 increases the charging current by 0.2 A at a time. The control unit 220 may increase the charging current on condition that a predetermined period of time elapses since the charging current increases immediately before. Next, the control unit 220 continuously performs the charging by an updated charging current (Act 100). The control unit 220 repeats the Acts 100 to 103 until the current value of the charging current reaches the target value.

If the current value of the charging current reaches the target value (Act 102, Yes), the control unit 220 continues the charging as it is (Act 104). The charging continues until the secondary battery 240 is fully charged. If the secondary battery 240 is fully charged, the control unit 220 ends the charging (Act 105, Yes) and ends a series of control.

When control of charging described above is started, the printer 200 may perform authentication processing by communication with the power supply device 100. If the authentication processing is performed, the power supply device 100 starts power transmission to the printer 200 after the authentication is completed.

As described above, the printer of the first embodiment determines that the printer is not placed at a proper position on the power supply device, based on the charging current which is set when the charging is stopped. With such a configuration, the user can receive a notification that the printer is not placed at a correct position on the power supply device only with the printer without mounting a special function on the power supply device.

### Second Embodiment

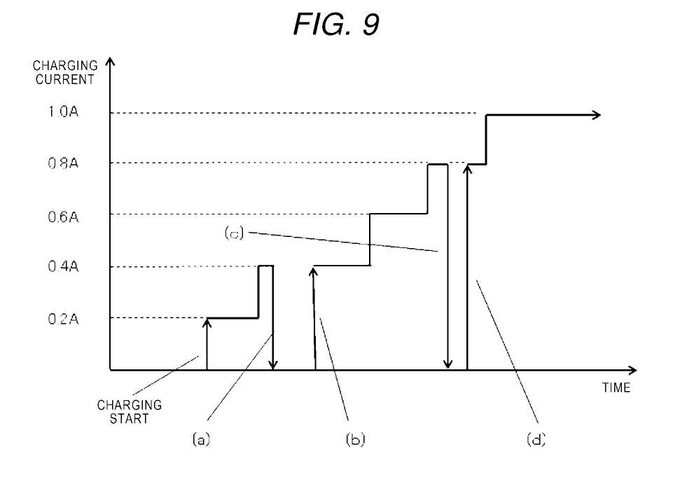

FIG. 9 is a diagram illustrating control by a control unit 220 of a power reception device according to a second embodiment. The second embodiment will be described with reference to FIG. 9. In the printer 200 of the second embodiment, if the user repositions the printer 200 after the power transmission from the power supply device 100 is stopped, the charging is resumed by the charging current when power transmission is stopped. Structures of the power supply device 100 and the printer 200 in the second embodiment are the same as those in the first embodiment.

With reference to FIG. 9, a relationship between the increase in the charging current by the control unit 220 and the power transmission stop of the power supply device 100 will be specifically described. The control unit 220 starts charging if the printer 200 is placed on the power supply device 100. First, the control unit 220 starts charging by a small current (0.2 A in example of FIG. 9) and controls the charging unit 215 so as to increase the current at regular time intervals. The power supply device 100 increases the power transmission output in order to supply the power requested by the printer 200. In the example of FIG. 9, if charging current increases to 0.4 A, power transmission is stopped (FIG. 9(a)). The reason is because since the position at which the printer 200 is placed is shifted from the center of the power supply device 100, the efficiency thereof decreases and before the power requested by the printer 200 is transmitted, the power supply device 100 reaches the maximum value 7 W of the power that can be transmitted by the power supply device 100.

The control unit 220 determines a state of the position of the printer 200 based on the current value of the charging current when the charging is stopped and the user receives a notification of the state by the display unit 230. As a result, if the printer 200 is repositioned by the user, the power reception is started again. At this time, the charging is started again from the current value of the charging current when the charging is stopped (FIG. 9(b)).

The subsequent processing is the same as that in the first embodiment. In addition, if the power transmission for the power supply device 100 is stopped again after the charging resumes (FIG. 9(c)), the display unit 230 again notifies that the position of the printer 200 is shifted. As a result, if the printer 200 is repositioned again by the user, the power reception is started again. At this time, charging resumes from the current value of the charging current when the last charging is stopped (FIG. 9(d)).

In the second embodiment, when the charging is resumed after the charging is stopped, the control unit 220 resumes the charging from the current value of the charging current when the power transmission is stopped. Since the printer can be expected to be repositioned at the further center position thereof when the user repositions the printer 200, the current value of the charging current is not required to set to the current value of the charging current which is set immediately before the power transmission is stopped for charging. By controlling the control unit as described above, determination with respect to whether or not the center of the power reception coil 205 is placed at a proper position can be performed in a short time.

As described above, the printer according to each of the embodiments can determine that the printer is not placed at a proper position on the power supply device based on the charging current that is set when power transmission from the power supply device is stopped.

The power reception unit and the charging unit in these embodiments are not clearly distinguished from each other and may be treated as a power reception unit which is a combination of the power reception unit and the charging unit with each other.

In the examples of these embodiments, although the region where the printer is placed is calculated from the current value of the charging current at the time of the charging being stopped, these relationships may be prepared in advance as a table and be stored in the memory of the printer in a callable state.

The power reception device is not limited to a portable printer but may be a mobile device such as a smart phone. Like the portable printer, the smart phone is also provided with a display unit and a load.

The values of the current value and the efficiency of the charging current described in these embodiments are merely examples and are not limited to the above values. In addition, although a secondary battery is exemplified as a load, the load is not limited to a secondary battery, and the load may be a circuit constituting a power reception device, for example.

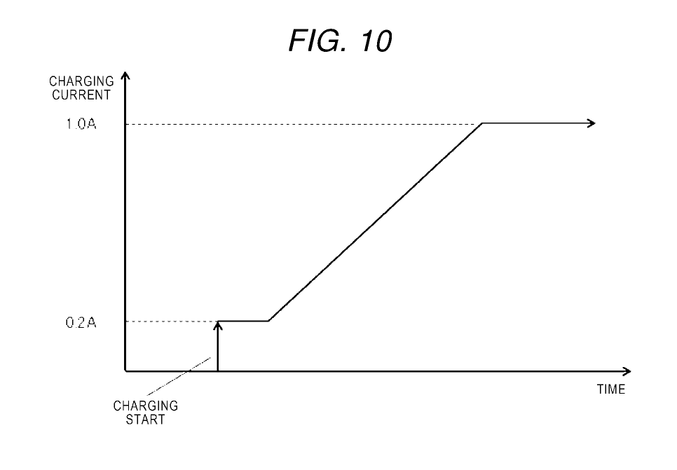

In the above examples, although the charging current after the charging is started increases step by step, as an example, the charging current is not limited to this example. For example, FIG. 10 is a diagram illustrating another example of control by the control unit of the power reception device. Accordingly, the control unit of the power reception device may continuously increase the current value of the charging current instead of step by step.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power reception device comprising:
a power reception coil that receives power from a power supply device in a non-contact manner;
a power reception unit configured to cause the received power as a charging current to flow to a load;
a control unit configured to start charging by a charging current value, to detect an actual current value, to request adjustment of the transmitted power to the power supply device and to notify a notification unit that a relative position of the power reception device to the power supply device is inappropriate based on the charging current value.

2. The device according to claim 1,
wherein the control unit calculates charging efficiency based on a current value of the charging current when the charging stops and notifies the notification unit of the charging efficiency.

3. The device according to claim 1,
wherein the notification unit displays the relative position of the power reception device to the power supply device and the control unit calculates the relative position based on the charging current value of the charging current when the charging stops and notifies the notification unit of the relative position.

4. The device according to claim 1,
wherein the control unit increases the charging current by a predetermined amount at predetermined time intervals.

5. The device according to claim 1,
wherein the control unit starts the charging from the charging current value of the charging current which is set when the charging stops if the charging starts again by the relative position being changed after the charging stops.

6. The device according to claim 1,
wherein the load comprises a secondary battery.

7. The device according to claim 1,
wherein the load comprises a lithium ion battery.

8. A method for controlling a power reception device which charges power in a non-contact manner, the method comprising:
receiving power;
causing the received power as a charging current to flow to a load;
starting charging by a charging current value;
detecting an actual current value;
requesting adjustment of the transmitted power to the power supply device; and
notifying a notification unit that a relative position of the power reception device to a power supply device is inappropriate based on the charging current value.

9. The method according to claim 8 further comprising:
calculating charging efficiency based on a current value of the charging current value when the charging stops; and
notifying the notification unit of the charging efficiency.

10. The method according to claim 8 further comprising:
displaying the relative position of the power reception device to the power supply device;
calculating the relative position based on the current value of the charging current when the charging stops; and
notifying the notification unit of the relative position.

11. The method according to claim 8 further comprising:
increasing the charging current by a predetermined amount at predetermined time intervals.

12. The method according to claim 8 further comprising:
starting the charging from the current value of the charging current which is set when the charging stops if the charging is started again by the relative position being changed after the charging stops.

13. A printer comprising a printing section and a power reception device, the power reception device comprising:
a power reception coil that receives power from a power supply device in a non-contact manner;
a power reception unit configured to cause the received power as a charging current to flow to a load;
a control unit configured to start charging by a charging current value, to detect an actual current value, to request adjustment of the transmitted power to the power supply device and to notify a notification unit that a relative position of the power reception device to the power supply device is inappropriate based on the charging current value.

14. The printer according to claim 13,
wherein the control unit calculates charging efficiency based on a current value of the charging current when the charging stops and notifies the notification unit of the charging efficiency.

15. The printer according to claim 13,
wherein the notification unit displays the relative position of the power reception device to the power supply device and the control unit calculates the relative position based on the charging current value of the charging current when the charging stops and notifies the notification unit of the relative position.

16. The printer according to claim 13,
wherein the control unit increases the charging current by a predetermined amount at predetermined time intervals.

17. The printer according to claim 13,
wherein the control unit starts the charging from the charging current value of the charging current which is set when the charging stops if the charging starts again by the relative position being changed after the charging stops.

18. The printer according to claim 13,
wherein the load comprises a secondary battery.

19. The printer according to claim 13,
wherein the load comprises a lithium ion battery.

20. The printer according to claim 13,
wherein the printer is a portable printer.
